(19) United States
(12) Patent Application Publication
(10) Pub. No.: US 2013/0185406 A1
(43) Pub. Date: Jul. 18, 2013

(54) COMMUNICATION METHOD OF TARGET NODE TO PREFETCH SEGMENTS OF CONTENT IN CONTENT-CENTRIC NETWORK (CCN) AND TARGET NODE

(71) Applicants: Sung Chan CHOI, Uijeongbu-si (KR); Ji Hoon LEE, Anyang-si (KR); Byoung Joon LEE, Seongnam-si (KR); Myeong Wuk JANG, Seoul (KR)

(72) Inventors: Sung Chan CHOI, Uijeongbu-si (KR); Ji Hoon LEE, Anyang-si (KR); Byoung Joon LEE, Seongnam-si (KR); Myeong Wuk JANG, Seoul (KR)

(73) Assignee: SAMSUNG ELECTRONICS CO., LTD., Suwon-si (KR)

(21) Appl. No.: 13/567,312

(22) Filed: Aug. 6, 2012

(30) Foreign Application Priority Data
Jan. 12, 2012 (KR) 10-2012-0003894

(51) Int. Cl. G06F 15/16

(52) U.S. Cl. 709/223

(57) ABSTRACT

A target node and a communication method of using a target node that is configured to prefetch a segment of content in a Content-Centric Network (CCN) are provided. A communication method involving a target node configured to prefetch a segment of content in a Content-Centric Network (CCN) involves: receiving, from a previous node, a predetermined content-request packet requesting a predetermined segment of a content; determining a prefetching window size based on a number of segments in response to the predetermined content-request packet, the segments being prefetched based on a name of the content; generating a content-request packet that requests each of the segments based on the prefetching window size; and transmitting the generated content-request packet to a next node.

### CROSS-REFERENCE TO RELATED APPLICATIONS)

This application claims the benefit under 35 U.S.C. § 119(a) of Korean Patent Application No. 10-2012-0003894, filed on Jan. 12, 2012, in the Korean Intellectual Property Office, the entire disclosure of which is incorporated herein by reference for all purposes.

### BACKGROUND

1. Field

The following description relates to a target node and to a communication method of using a target node to prefetch segments of content in a Content-Centric Network (CCN).

2. Description of Related Art

In a networking environment that employs a scheme of requesting content based on a name of the content and of receiving the content based on such a request, a single content may be divided into a plurality of segments. Additionally, a content name and a segment number may be attached to each of these segments.

Schemes of requesting content in such a networking environment include a one-to-one scheme and a scheme that uses a pipeline. The one-to-one scheme involves requesting a segment subsequent to a previously requested segment when a content requester transmits a content-request packet and receives the content in response to the content-request packet. The scheme using a pipeline involves transmitting a content-request packet corresponding to a window size using a pipeline and waiting for the content in response to the content-request packet.

However, the length of time it takes for a content requester to request content and the requested content to be transferred to the content requester may vary depending on the network situation. In addition, formatting a content-request packet in such a way that a plurality of segments is transmitted during a short period of time to increase a transmission throughput of a network may cause a bottleneck in the network.

Additionally, a change in network delay time may lead to a delay jitter. This may cause contents to arrive at the content requester after irregular time delay, potentially reducing the quality of a streaming service that is sensitive to time. As a result, transferring packets without considering the network situation may reduce the quality of the network.

### SUMMARY

In one general aspect, there is provided a communication method involving a target node configured to prefetch a segment of content in a Content-Centric Network (CCN), the communication method involving: receiving, from a previous node, a predetermined content-request packet requesting a predetermined segment of a content; determining a prefetching window size based on a number of segments in response to the predetermined content-request packet, the segments being prefetched based on a name of the content; generating a content-request packet that requests each of the segments based on the prefetching window size; and transmitting the generated content-request packet to a next node.

The determining may involve determining the prefetching window size, based on one or more of a first service time measured between the previous node and the target node, a second service time measured between the target node and the next node, a bandwidth for the CCN, and a user-defined value.

The method may further involve updating the prefetching window size based on the first service time and the second service time.

The method may further involve estimating a prefetching window size, using an average value of first service times measured between the previous node and the target node for a predetermined period of time and an average value of second service times measured between the target node and the next node for a predetermined period of time, and the determining may involve determining the estimated prefetching window size to be the prefetching window size.

The method may further involve determining a prefetching window size for each content name included in the predetermined content-request packet.

The method may further involve determining whether to transmit content-request packets to the next node based on the prefetching window size and a difference between a first value and a second value, the first value being incremented each time the target node transfers a content-request packet requesting a single segment among the segments, and the second value being incremented each time the target node transfers a segment received in response to a content-request packet to a node that requests the segment.

The determining may involve determining to transmit the content-request packets to the next node in response to the difference between the first value and the second value being less than the prefetching window size.

The method may further involve generating a management table, the management table configured to be used in managing the prefetched segments with respect to each content name, and the management table may be managed based on a prefetching window size for each content name.

The target node may include network equipment, a router or a proxy.

in another aspect, there is provided a non-transitory computer readable recording medium storing a program to cause a computer to implement the method described above.

In yet another aspect, there is provided a target node configured to prefetch a segment of content in a Content-Centric Network (CCN), the target node including: a network module configured to receive, from a previous node, a predetermined content-request packet requesting a predetermined segment of a content; a processor configured to determine a prefetching window size based on a number of segments, in response to the predetermined content-request packet, and to generate a content-request packet requesting each of the segments, based on the prefetching window size, the segments being prefetched based on a name of the content; and a memory configured to store a segment received in response to the generated content-request packet.

The processor may be configured to determine the prefetching window size based on one or more of a first service time measured between the previous node and the target node, a second service time measured between the target node and the next node, a bandwidth for the CCN, and a user-defined value.

The processor may be configured to update the prefetching window size based on the first service time and the second service time.

The processor may be configured to estimate a prefetching window size, using an average value of first service times measured between the previous node and the target node for a predetermined period of time, and an average value of second service times measured between the target node and the next node for a predetermined period of time.

The processor may be configured to determine a prefetching window size for each content name included in the predetermined content-request packet.

The processor may be configured to determine whether to transmit content-request packets to the next node, based on the prefetching window size and a difference between a first value and a second value, the first value being incremented each time the target node transfers a content-request packet for a single segment among the segments, and the second value being incremented each time the target node transfers a segment received in response to a content-request packet to a node that requests the segment.

The processor may be configured to determine whether to transmit the content-request packets to the next node based on whether the difference is less than the prefetching window size.

The memory may store a management table that is generated and used to manage the prefetched segments with respect to each content name, and the management table may be managed based on a prefetching window size for each content name.

The target node may include network equipment, a router or a proxy.

In another aspect, there is provided a router for receiving or transmitting content in a Content-Centric Network (CCN), the router including: a processor configured to determine a prefetching window size in response to a predetermined content-request packet requesting a predetermined segment of content, the router being configured to transmit one or more content-request packet to prefetch one or more segment subsequent to the predetermined segment.

The router may further include a memory configured to store a management table including the prefetching window size and a name of the content.

The processor may be configured to determine the prefetching window size based on one or more of a first service time measured between a previous node and the router, a second service time measured between the router and a next node, a bandwidth for the CCN, and a user-defined value.

The processor may be configured to determine the prefetching window size each time the router obtains the first service time and the second service time.

Other features and aspects will be apparent from the following detailed description, the drawings, and the claims.

### BRIEF DESCRIPTION OF THE DRAWINGS

FIG. 1 illustrates an example of a target node that transmits a content-request packet generated based on a prefetching window size.

FIG. 2 is a flowchart that illustrates an example of a communication method involving a target node that is configured to prefetch a segment of content in a Content-Centric Network (CCN).

FIG. 3 illustrates an example of an algorithm in which a target node dynamically controls a prefetching window size in a CCN.

FIG. 4 illustrates an example of a method of controlling a prefetching window size when a node requests content using a one-to-one scheme in a CCN.

FIG. 5 illustrates an example of a method of controlling a prefetching window size when a node requests content using a pipeline scheme in a CCN.

FIG. 6 illustrates an example of a management table.

FIG. 7 illustrates an example of a target node that is configured to prefetch a segment of content in a CCN.

FIG. 8 is a diagram that compares an example of a pipeline scheme and an example of a prefetching scheme that are used by a node to request content in a CCN.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be apparent to one of ordinary skill in the art. Any sequences of processing steps and/or operations described herein are merely examples, and the sequences of processing steps and/or operations are not limited to the specific examples set forth herein, and may be changed as will be apparent to one of ordinary skill in the art, with the exception of processing steps and/or operations necessary to occur in a certain order to carry out the methods. Also, description of well-known functions and constructions may be omitted for increased clarity and conciseness.

In an Internet Protocol (IP)-based network, contents are usually requested, searched and routed based on an IP address to the original owner of the content. However, in a CCN, contents may be requested, searched and routed based on a content name.

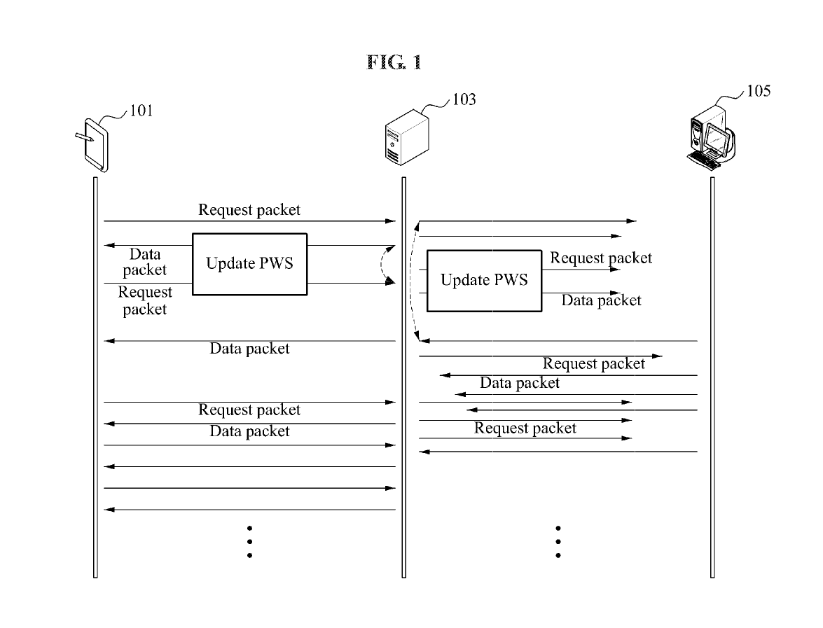

FIG. 1 illustrates an example of a target node that transmits a content-request packet generated based on a Prefetching Window Size, hereinafter referred to as a ‘PWS.’

Referring to FIG. 1, a target node 103 may receive a predetermined content-request packet requesting a predetermined segment from a previous node 101. After receiving the predetermined content request, the target node 103 may prefetch segments of the content by generating content-request packets that request segments that are subsequent to the predetermined segment. The generated content-request packets may be transmitted, for example, to nodes that include corresponding segments such as a next node 105. In this example, the target node 103 may be a proxy node.

In response to the predetermined content-request packet, the target node 103 may determine a PWS based on an input Round Trip Time (RTT) and an output RTT of the target node 103, and may transmit a content-request packet that is used to prefetch the content. The target node 103 may manage a number of segments to be prefetched by the PWS; thus, the target node 103 may manage a number of content-request packets. Hereinafter, the input RTT is referred to as RTTᵢₙ, and the output RTT is referred to as RTTₒᵤₜ.

When content that corresponds to the content-request packet is transferred to a network and is received by the target node 103, the target node 103 may cache the content. When a content-request packet for the content is received from the previous node 101 that requests the content, the content may be transferred from the content cache of the target node 103 directly to the previous node 101.

The PWS may be determined based on both a first service time measured between the previous node 101 and the target node 103 and a second service time measured between the target node 103 and the next node 105.

The first service time may be referred to as RTTᵢₙ. The first service time may be measured by transmitting an additional measurement packet used to measure an RTT between the previous node 101 and the target node 103. Additionally, the second service time may be referred to as RTTₒᵤₜ.

RTTᵢₙ may be determined as the amount of time required for the target node 103 to transfer a predetermined segment to the previous node 101 that is requesting the predetermined segment and to receive a content-request packet for a segment subsequent to the predetermined segment.

RTTₒᵤₜ may be determined as the amount of time required for the target node 103 to transmit a content-request packet to the next node 105 and to receive a segment of a content corresponding to the content-request packet from the next node 105.

The PWS may be updated each time the target node 103 acquires the first service time and the second service time.

For example, when an initial value of a first service time and an initial value of a second service time are not set, the target node 103 may estimate a PWS, using an average value of first service times measured for a predetermined period of time and an average value of second service times measured for a predetermined period of time. In this example, the target node 103 may use the estimated PWS as a PWS.

The PWS may be maintained and calculated with respect to contents with the same names. In other examples, the PWS may be maintained and controlled for each link interface.

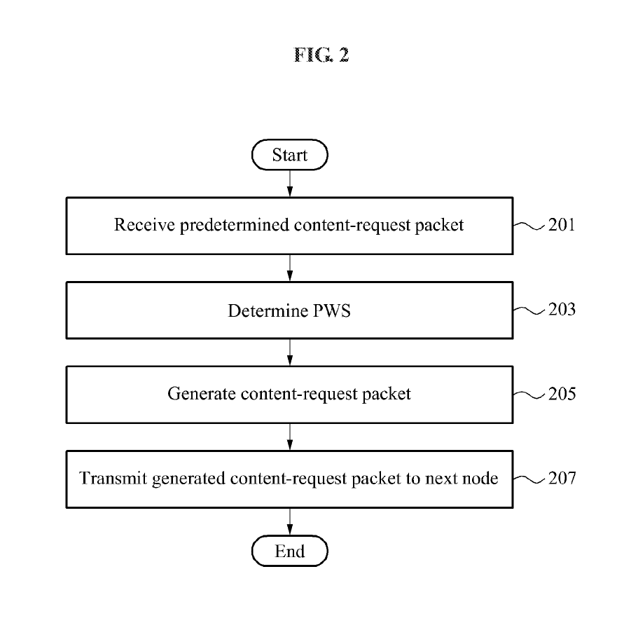

FIG. 2 illustrates an example of a communication method involving a target node that is configured to prefetch a segment of content in a Content-Centric Network (CCN).

In this example, the target node may be configured to prefetch a segment of content in a CCN. In a CCN, content is requested based on a name of the content, and the routing is performed based on the name of the content. The target node may include, for example, network equipment, a router, a proxy, and/or various apparatuses with a function of prefetching segments of content.

Referring to FIG. 2, in 201, the target node receives, from a previous node, a predetermined content-request packet that requests a predetermined segment of content.

In 203, the target node determines a PWS in response to the predetermined content-request packet. In an example, the target node may determine the PWS based on the number of segments. The segments may include the predetermined segment, and may be prefetched based on a name of the content.

In another example, the target node may determine the PWS based on a first service time, a second service time, a bandwidth for the CCN, a user-defined value, or a combination thereof. The first service time may be measured between the previous node and the target node, and the second service time may be measured between the target node and a next node.

In an example, the target node may dynamically determine a PWS based on a content name included in a content-request packet, taking into consideration a variety of factors, including: the first service time, the second service time, and/or a size of a pipeline used by a node that is requesting the content in order to transmit the content-request packet.

In another example, the target node may determine a PWS for each content name included in a predetermined content-request packet.

In 205, the target node generates a content-request packet. The content-request packet may request each of the segments based on the PWS. In 207, the target node transmits the generated content-request packet to the next node.

In an example, the target node may determine whether to prefetch next segments, based on the PWS and a difference between a first value and a second value.

In this example, the first value may refer to a value of a Last Interest Sent, hereinafter referred to as a ‘LIS.’ The value of the LIS may indicate a number of segments requested last by the target node, and the value may be incremented each time the target node transfers a content-request packet for a segment among the segments.

Additionally, the second value may refer to a value of a Last Content Delivered, hereinafter referred to as an ‘LCD.’ The value of the LCD may indicate a number of segments transferred last by the target node, and the value may be incremented each time the target node transfers a segment received in response to a content-request packet to a node requesting the segment.

Based on whether the difference between the first value and the second value is less than or greater or equal to the PWS, the target node may determine whether to transmit content-request packets to the next node.

The target node may prefetch segments that are subsequent to a predetermined segment based on a content name. In addition, the target node may, in advance, store the prefetched segments in a content cache. Accordingly, the target node may provide the prefetched segments to a node requesting the segments without an additional delay.

In an example, the target node that is configured to prefetch segments of content exists in the same local network as a content requesting node. In other examples, the target node that is configured to prefetch segments of content exists in a different local network from the content requesting node that is requesting the content.

Hereinafter, an example in which the target node exists in the same local network as the content requesting node is described.

In this example, RTTᵢₙ between a target node and a content requesting node is set to 60 ins. When RTTₒᵤₜ measured between the target node and the Yahoo? domain is set to 220 ms, the content requesting node may be provided with content requested by the content requesting node through a prefetching operation performed by the target node without reaching the Yahoo? domain. Alternatively, the Yahoo? domain may provide the requested content. When the content is obtained with the prefetching operation, a delay in RTTₒᵤₜ may be reduced. Thus, the content may be quickly provided to the content requesting node. Additionally, the target node may offset a change in delay time based on RTTₒᵤₜ, and may improve the performance of a streaming service that is sensitive to time.

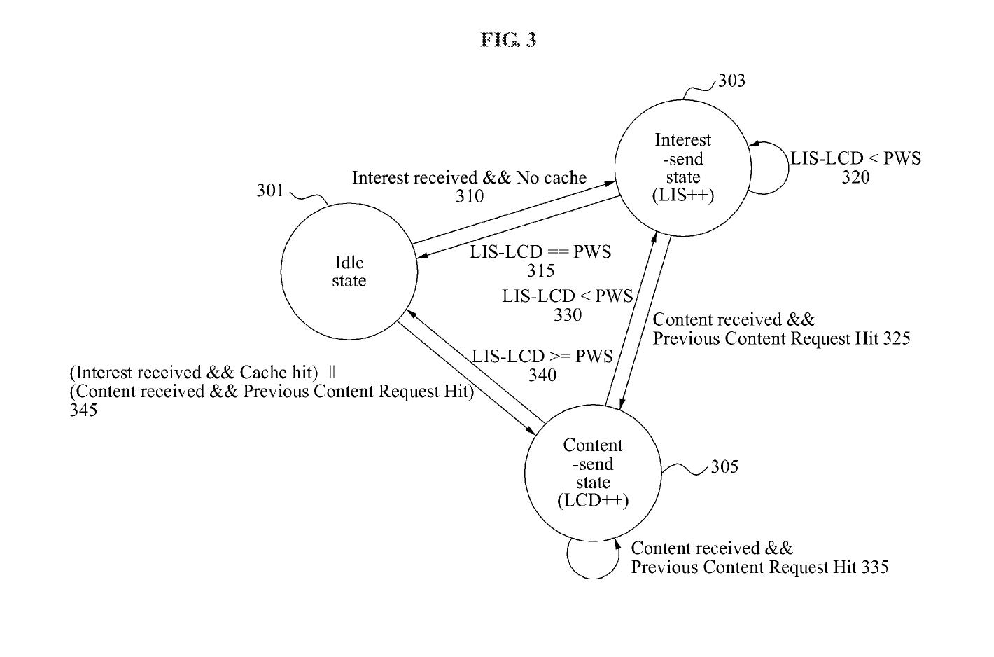

FIG. 3 illustrates an example of an algorithm in which a target node dynamically controls a PWS in a CCN.

In this example, the target node is configured to prefetch segments of content, and the target node increments a first value, namely, a value of an LIS, each time the target node transfers a content-request packet for a predetermined segment among the segments.

Additionally, the target node increments a second value, namely, a value of an LCD, each time the target node transfers a segment received in response to a content-request packet to a node requesting the segment. The target node may store the received segment in a content cache.

The target node may define a PWS as a difference between the value of the LIS and the value of the LCD, based on various algorithms.

The target node may determine a PWS based on one or more of a first service time measured between a previous node and the target node, a second service time measured between the target node and a next node, a bandwidth for the CCN, and a value defined by user's heuristics, namely a user-defined value. Additionally, the target node may generate a content-request packet that requests each of segments prefetched based on the name of content. Further, the target node may transfer the generated content-request packet, and may change a control state based on the PWS.

The algorithm illustrated in FIG. 3 has three control states: an idle state 301, an interest-send state 303, and a content-send state 305.

For example, if a content-request packet is received in the idle state 301, the target node may determine whether a content corresponding to the content-request packet is cached in a memory of the target node. The memory may include, for example, a content cache of the target node.

In this example, in the event that the content is not cached in the content cache, the target node may change a control state of the target node from the idle state 301 to the interest-send state 303, and may transfer the received content-request packet to an outgoing interface, as in 310. Through the above process, the target node may increment the value of the LIS by ‘1’.

Conversely, in the event that the content is cached in the content cache, the target node may increment the value of the LCD by ‘1’ through a process of receiving a requested content and transmitting the requested content via an incoming interface, through which the content-request packet is received, for example, as in 345.

In the algorithm illustrated in FIG. 3, in the event that a difference between the LIS and the LCD is less than the PWS (LIS-LCD<PWS) in the interest-send state 303, the target node transmits a content-request packet requesting at least one next segment in contents with the same names, and attempts to prefetch the next segment, as illustrated in 320.

In the event that the content-request packet requesting the next segment is transmitted, and the difference between the LIS and the LCD becomes equal to the PWS (LIS-LCD=PWS), the control state of the target node returns to the idle state 301, as illustrated in 315.

In the event that the content-request packet is received and a segment corresponding to the content-request packet is cached in the memory of the target node, as illustrated in 335, the target node may change the control state to the content-send state 305, as illustrated in 325. In the event that a segment that corresponds to a content-request packet arrives by requesting the segment using an outgoing interface, since the segment does not exist, despite the content-request packet being already received via an incoming interface of the target node, the target node may also change the control state to the content-send state 305, as illustrated in 325. Additionally, the target node may transfer the segment through the incoming interface via which the content-request packet is received.

A content transfer in accordance with the above-described process may result in incrementing the value of the LCD by ‘1’.

In the event that the difference between the LIS and the LCD is less than the PWS (LIS-LCD<PWS), the target node changes the control state to the interest-send state 303, as illustrated in 330. In the event that the difference between the LIS and the LCD is equal to or greater than the PWS (LIS-LCD≧PWS), the target node changes the control state to the idle state 301, as illustrated in 340.

The target node may update the PWS based on RTTᵢₙ and RTTₒᵤₜ. RTᵢₙ and RTTₒᵤₜ may be measured each time a content-request packet is transmitted and a corresponding content is received via an incoming interface and an outgoing interface.

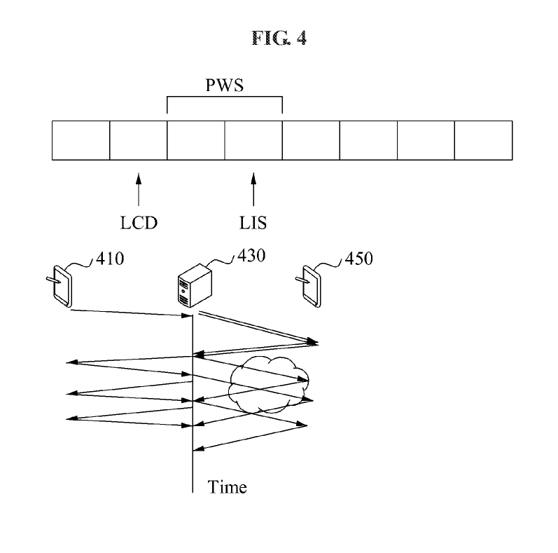

FIG. 4 illustrates an example of a method of controlling a PWS when a node requests content using a one-to-one scheme in a CCN.

In FIG. 4, when a previous node 410 requests content using the one-to-one scheme and RTTₒᵤₜ of a target node 430 is greater than twice RTTᵢₙ of the target node 430, a PWS may be set.

For example, when a content-request packet associated with a new name is received for the first time, the target node 430 may set an average value of RTTᵢₙ and RTTₒᵤₜ that are previously experienced by the target node 430 as an estimated RTT, and may determine a PWS based on the estimated RTT. The estimated RTT is hereafter referred to as RTTₑₛₜᵢₘₐₜₑ.

Subsequently, the target node 430 may update RTTₒᵤₜ each time a content that corresponds to the content-request packet is received. Additionally, the target node 430 may update RTTᵢₙ when the content or a segment of the content is transferred to an interface in a direction which a node requesting the content exists, and a content-request packet requesting a segment subsequent to the transferred segment is received.

Furthermore, the target node 430 may measure RTTᵢₙ and RTTₒᵤₜ by exchanging a packet used to measure a background RTT with the previous node 410 and a next node 450.

The target node 430 may calculate RTTᵢₙ and RTTₒᵤₜ by applying different weights to RTTₑₛₜᵢₘₐₜₑ and a newly updated RTT, referred to as RTT_{update}, as shown in the following Equation 1:

$${RTT}_{estimate} = α \times {RTT}_{estimate} + ( 1 - α ) \times {RTT}_{update} \\ PWS = ⌈ \frac{{RTT}_{out - estimate}}{{RTT}_{in - estimate}} ⌉ \qquad [ Equation 1 ]$$

In Equation 1, α denotes a value defined by a user, and may be determined based on how the user applies weights to RTTₑₛₜᵢₘₐₜₑ and RTT_{update}.

In an example, the target node 430 may determine a PWS based on RTTᵢₙ and RTTₒᵤₜ using Equation 1 described above.

In another example, the target node 430 may set a PWS to a ceiling integer of a value obtained by dividing RTTₒᵤₜ by RTTᵢₙ. In still another example, the target node 430 may determine a PWS, by maintaining a predetermined margin in an integer value obtained from an algorithm used to determine a PWS, or by using a user-defined value.

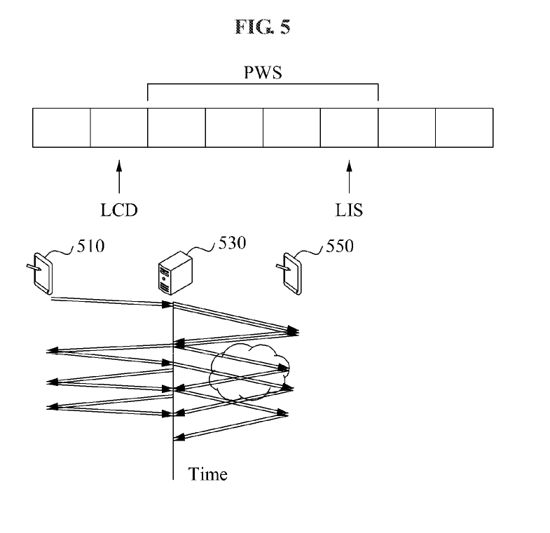

FIG. 5 illustrates an example of a method of controlling a PWS when a node requests content using a pipeline scheme in a CCN.

In FIG. 5, if a previous node 510 requests content or a segment of the content by setting a pipeline size to ‘2’, and RTTₒᵤₜ of a target node 530 is greater than twice RTTᵢₙ of the target node 530, a PWS may be set.

In this example, the PWS may be managed for each name prefix of requested content, and may be changed by updating an RTT. If data regarding the RTT does not exist, the RTT may be updated from an average RTT value that is previously experienced by the target node 530.

For example, in the event that a content-request packet associated with a new name is received for the first time, the target node 530 may set RTTₑₛₜᵢₘₐₜₑ to an average value of original RTTᵢₙ and original RTTₒᵤₜ, and may determine a PWS based on the average value.

Subsequently, RTTₒᵤₜ may be updated each time a content-request packet is transmitted from the target node 530 to a next node 550, and content that corresponds to the content-request packet is received from the next node 550. Additionally, RTTᵢₙ may be updated each time the target node 530 transfers a content corresponding to a content-request packet to a registered interface towards the previous node 510 requesting the content, and then receives a new content-request packet from the previous node 510.

In an example, a method of setting a period in which an RTT is updated based on an additional overhead and updating the RTT at each period may be applied.

Additionally, RTTᵢₙ may be measured by exchanging a packet used to measure a background RTT between the target node 530 and the previous node 510.

RTTₑₛₜᵢₘₐₜₑ associated with RTTᵢₙ and RTTₒᵤₜ may be updated by applying different weights (for example, α and 1−α) to an original RTTₑₛₜᵢₘₐₜₑ and a newly updated RTT, referred to as RTT_{update}, as shown in the following Equation 2:

$${RTT}_{estimate} = α \times {RTT}_{estimate} + ( 1 - α ) \times {RTT}_{update} \\ PWS = PipelineSize \times ⌈ \frac{{RTT}_{out - estimate}}{{RTT}_{in - estimate}} ⌉ \qquad [ Equation 2 ]$$

In Equation 2, α denotes a value defined by a user, and may be determined based on how the user applies weights to RTTₑₛₜᵢₘₐₜₑ and RTT_{update}.

The PWS may be determined based on RTTₑₛₜᵢₘₐₜₑ calculated as described above. The PWS may be determined by multiplying a ceiling integer of a value obtained by dividing RTTₒᵤₜ by RTTᵢₙ, as shown in Equation 2, by a pipeline size of a node requesting a content received by the target node 530.

The pipeline size may be shared to set a connection between the target node 530 and a node requesting content, for example the previous node 510. Additionally, a content requesting node may set a single field indicating the pipeline size in a content-request packet, and may transfer the content-request packet.

Additionally, to determine a PWS using Equation 2, the target node 530 may use a heuristic method of maintaining a predetermined margin in an obtained integer value.

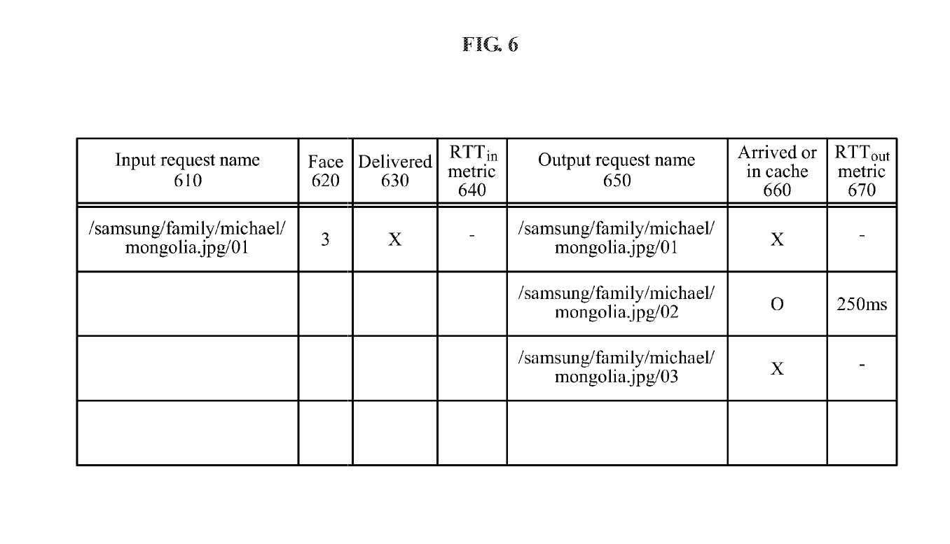

FIG. 6 illustrates an example of a management table. The management table may be generated by a target node, and may be used to manage prefetched segments. Referring to FIG. 6, when a content-request packet is received by applying a PWS control algorithm, the target node may write and manage a management table, based on a name of content other than a segment number.

In the example illustrated in FIG. 6, a request for a first segment of ‘mongolia.jpg’ is received, and a PWS is determined to be ‘3’ using the PWS control algorithm.

The target node may generate content-request packets respectively requesting the first segment, a second segment, and a third segment, and may transmit the generated content-request packets. The name of each of the first to third segments requested respectively by the content-request packets are described in an output request name field 650 of FIG. 6.

For example, when content corresponding to the output request name field 650 is received, the target node may check an arrived-or-in-cache field 660, and may set a value of an RTTₒᵤₜ metric field 670. When the received content is identical to the content described in an input request name field 610, the target node may transmit the received content via a face described in a face field 620, and may check a delivered field 630 to determine whether the content is transmitted. In this example, the target node may set a value of an RTTᵢₙ metric field 640.

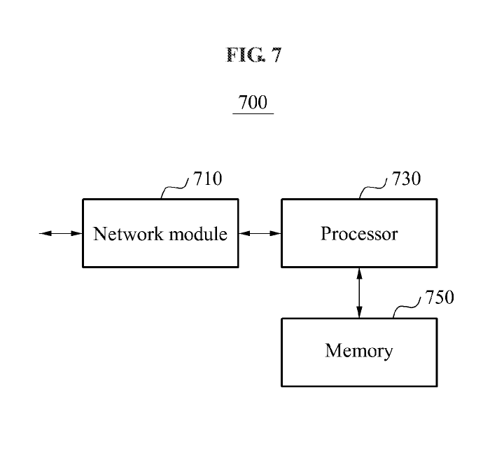

FIG. 7 illustrates an example of a target node configured to prefetch a segment of content in a CCN.

In FIG. 7, a target node 700 is configured to prefetch a segment of content in a CCN. In a CCN, contents are requested based on a name of the content and routing is performed by the target node 700. The target node 700 includes a network module 710, a processor 730, and a memory 750.

The network module 710 may receive from a previous node a predetermined content-request packet that requests a predetermined segment of content.

The processor 730 may determine a PWS, based on a number of segments that include the predetermined segment in response to the predetermined content-request packet; then, the processor 730 may generate a content-request packet that requests each of the segments on the basis of the PWS. The segments may be prefetched based on the name of the content.

The processor 730 may determine the PWS based on one or more of a first service time measured between the previous node and the target node 700, a second service time measured between the target node 700 and the next node, a bandwidth for the CCN, and a user-defined value.

The processor 730 may update the PWS based on the first service time and the second service time.

The processor 730 may estimate a PWS, using an average value of first service times measured between the previous node and the target node 700 for a predetermined period of time and an average value of second service times measured between the target node 700 and the next node for a predetermined period of time.

The memory 750 may store a segment received in response to the generated content-request packet.

The memory 750 may store a management table that is generated and used to manage the prefetched segments with respect to each content name. The management table may be managed based on a PWS for each content name.

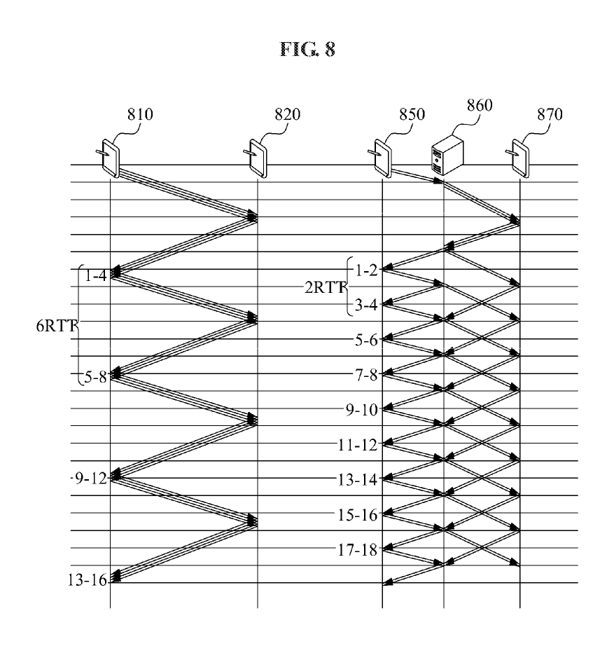

FIG. 8 compares an example of a pipeline scheme and an example of a prefetching scheme that are used by a node to request content in a CCN.

As illustrated on the left side of the diagram depicted in FIG. 8, when a pipeline scheme is used, a content requesting node transmits a large number of content-request packets by applying only a large-sized pipeline. The prefetching operation is not used. On the other hand, as illustrated on the right side of the diagram depicted in FIG. 8, when a prefetching scheme is used, a content requesting node applies a small-sized pipeline and applies a prefetching scheme by target node.

In an example of applying the large-sized pipeline, a large number of on-the-fly messages starting from a terminal 810 may be generated. In this example, when a user terminal 820, to which the on-the-fly messages arrive, interrupts a streaming service, the pipeline scheme may cause resources and energy to be wasted. Additionally, when the large-sized pipeline is used, the terminal 810 may cause congestion of a network due to more bursty traffic.

As illustrated in FIG. 8, an RTT on the left side of the diagram in FIG. 8 may be set to ‘6,’ and an RTT on the right side of the diagram in FIG. 8 may be set to ‘2.’ In this example, if a packet loss occurs due to an RTT, a packet recovery time may lengthen in the case in which one large-sized pipeline is applied, in comparison to the case in which the prefetching scheme is applied. As a result, a delay jitter may be amplified when a large-sized pipeline is used, possibly reducing the quality of a streaming service that is sensitive to time.

The above problems may be alleviated by using a prefetching method.

For example, in the event that a content requested by a previous node 850 is stored in a content cache of a target node 860, the target node 860 may obtain a desired content through the prefetching operation based on a caching effect, without a need to reach a next node 870 that includes the requested content. Accordingly, the previous node 850 may more quickly download the content. Further, it is possible to improve the quality of the streaming service.

In a networking environment that employs a scheme of requesting content based on a name of the content and receiving the requested content, a delay in transferring a content-request packet and receiving content in response to the content-request packet may vary depending on the situation of the network. Additionally, transferring a content-request packet without considering the network situation may cause a bandwidth to be wasted.

Accordingly, by using a prefetching operation to prefetch content or a segment of content, it is possible for a content requesting node to quickly fetch a requested content from a target node, and to improve the performance in the event there is a network delay. Additionally, it is possible to dynamically control a PWS based on the network situation by dynamically updating the PWS based on an input RTT and an output RTT of a target node.

According to other examples, by prefetching segments including a predetermined segment based on a name of the content, it may be possible to more quickly transfer a content requested by a content requester in comparison to a case in which prefetching operations are not used.

Additionally, according to other examples, a PWS may be determined based on a first service time measured between a previous node and a target node, and a second service time measured between the target node and a next node; thus, it is possible to dynamically adjust a number of prefetched segments based on a network situation, and to prevent the waste of a network bandwidth and the possible reduction in the quality of the network.

The method according to the above-described examples may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts.

Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A node may be a terminal, a mobile device, a computer, a server, a router and the like. As a non-exhaustive illustration only, a terminal/device/unit/module described herein may refer to a mobile device such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

The units and modules described herein may be implemented using hardware components and software components. These include transmitters, receivers, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

Several examples have been described above. Nevertheless, it should be understood that various modifications may be made in these examples. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the claims and their equivalents.

What is claimed is:

1. A communication method involving a target node configured to prefetch a segment of content in a Content-Centric Network (CCN), the communication method comprising:
receiving, from a previous node, a predetermined content-request packet requesting a predetermined segment of a content;
determining a prefetching window size based on a number of segments in response to the predetermined content-request packet, the segments being prefetched based on a name of the content;
generating a content-request packet that requests each of the segments based on the prefetching window size; and
transmitting the generated content-request packet to a next node.

2. The communication method of claim 1, wherein the determining comprises determining the prefetching window size, based on one or more of a first service time measured between the previous node and the target node, a second service time measured between the target node and the next node, a bandwidth for the CCN, and a user-defined value.

3. The communication method of claim 2, further comprising:
updating the prefetching window size based on the first service time and the second service time.

4. The communication method of claim 1, further comprising:
estimating a prefetching window size, using an average value of first service times measured between the previous node and the target node for a predetermined period of time and an average value of second service times measured between the target node and the next node for a predetermined period of time,
wherein the determining comprises determining the estimated prefetching window size to be the prefetching window size.

5. The communication method of claim 1, further comprising:
determining a prefetching window size for each content name included in the predetermined content-request packet.

6. The communication method of claim 1, further comprising:
determining whether to transmit content-request packets to the next node based on the prefetching window size and a difference between a first value and a second value, the first value being incremented each time the target node transfers a content-request packet requesting a single segment among the segments, and the second value being incremented each time the target node transfers a segment received in response to a content-request packet to a node that requests the segment.

7. The communication method of claim 6, wherein the determining comprises determining to transmit the content-request packets to the next node in response to the difference between the first value and the second value being less than the prefetching window size.

8. The communication method of claim 1, further comprising:
generating a management table, the management table configured to be used in managing the prefetched segments with respect to each content name,
wherein the management table is managed based on a prefetching window size for each content name.

9. The communication method of claim 1, wherein the target node comprises network equipment, a router or a proxy.

10. A non-transitory computer readable recording medium storing a program to cause a computer to implement the method of claim 1.

11. A target node configured to prefetch a segment of content in a Content-Centric Network (CCN), the target node comprising:
a network module configured to receive, from a previous node, a predetermined content-request packet requesting a predetermined segment of a content;
a processor configured to determine a prefetching window size based on a number of segments, in response to the predetermined content-request packet, and to generate a content-request packet requesting each of the segments, based on the prefetching window size, the segments being prefetched based on a name of the content; and
a memory configured to store a segment received in response to the generated content-request packet.

12. The target node of claim 11, wherein the processor is configured to determine the prefetching window size based on one or more of a first service time measured between the previous node and the target node, a second service time measured between the target node and the next node, a bandwidth for the CCN, and a user-defined value.

13. The target node of claim 12, wherein the processor is configured to update the prefetching window size based on the first service time and the second service time.

14. The target node of claim 11, wherein the processor is configured to estimate a prefetching window size, using an average value of first service times measured between the previous node and the target node for a predetermined period of time, and an average value of second service times measured between the target node and the next node for a predetermined period of time.

15. The target node of claim 11, wherein the processor is configured to determine a prefetching window size for each content name included in the predetermined content-request packet.

16. The target node of claim 11, wherein the processor is configured to determine whether to transmit content-request packets to the next node, based on the prefetching window size and a difference between a first value and a second value, the first value being incremented each time the target node transfers a content-request packet for a single segment among the segments, and the second value being incremented each time the target node transfers a segment received in response to a content-request packet to a node that requests the segment.

17. The target node of claim 16, wherein the processor is configured to determine whether to transmit the content-request packets to the next node based on whether the difference is less than the prefetching window size.

18. The target node of claim 11, wherein the memory stores a management table that is generated and used to manage the prefetched segments with respect to each content name,
wherein the management table is managed based on a prefetching window size for each content name.

19. The target node of claim 11, wherein the target node comprises network equipment, a router or a proxy.

20. A router for receiving or transmitting content in a Content-Centric Network (CCN), the router comprising:
a processor configured to determine a prefetching window size in response to a predetermined content-request packet requesting a predetermined segment of content, the router being configured to transmit one or more content-request packet to prefetch one or more segment subsequent to the predetermined segment.

21. The router of claim 20, further comprising a memory configured to store a management table including the prefetching window size and a name of the content.

22. The router of claim 20, wherein the processor is configured to determine the prefetching window size based on one or more of a first service time measured between a previous node and the router, a second service time measured between the router and a next node, a bandwidth for the CCN, and a user-defined value.

23. The router of claim 22, wherein the processor is configured to determine the prefetching window size each time the router obtains the first service time and the second service time.
